(19) United States
(12) Patent Application Publication
(10) Pub. No.: US 2005/0085190 A1
(43) Pub. Date: Apr. 21, 2005

(54) Wireless communication system, wireless communication apparatus, wireless communication method and computer program

(75) Inventor: Kenzo Nishikawa, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/928,282

(22) Filed: Aug. 30, 2004

(30) Foreign Application Priority Data
Sep. 8, 2003 (JP) 2003-315280

(51) Int. Cl. H04B 1/00

(52) U.S. Cl. 455/63.1; 370/252

(57) ABSTRACT

In a wireless communication environment provided with a plurality of channels, a suitable ad hoc network is formed without mutual interference between communication stations. Each communication station acquires an average level of interference that a neighbor station receives for every channel, and a channel with the lowest average interference level is determined as a transmission channel. By weighting the interference of the neighbor station with a high priority for the local station, such as a destination station to which a large amount of packets is transmitted from the local station, to obtain a weighted average for each channel, a channel with less interference for a prioritized neighbor station for the local station is selected as the transmission channel. As a result, throughput of the entire system is improved.

### CROSS REFERENCES TO RELATED APPLICATIONS

The present document is based on Japanese Priority Document JP 2003-315280, filed in the Japanese Patent Office on Sep. 8, 2003, the entire contents of which being incorporated herein by reference.

### BACKGROUND OF THE INVENTION

1. Field of the Invention

The present invention relates to a wireless communication system for mutual communication among a plurality of wireless stations such as a wireless LAN (Local Area Network), a wireless communication apparatus, a wireless communication method and a computer program, and more particularly to a wireless communication system, a wireless communication apparatus, a wireless communication method and a computer program, in which a wireless network is configured by ad-hoc communication without relationship between a controlling station and a controlled station.

More in detail, the present invention relates to a wireless communication system, a wireless communication apparatus, a wireless communication method and a computer program, in which a self-organized distribution type wireless network is formed in a communication environment preparing a plurality of channels, without interference between neighboring wireless systems and without having a specific intervening controlling station, and more particularly to a wireless communication system, a wireless communication apparatus, a wireless communication method and a computer program, in which each communication station selects a suitable communication channel in a self-organized manner to form a self-organized distribution type multi-channel wireless network.

2. Description of Related Art

A wireless LAN has drawn attention as a system releasing a user from LAN wiring of a wired system. According to the wireless LAN, most of wired cables can be omitted in a working space such as an office so that communication terminals such as personal computers can be moved relatively easily. In recent years, demands for a wireless LAN system are increasing considerably because of its high speed and low cost. Introduction of a personal area network (PAN) has been studied recently in order to perform information communication by configuring a small-scaled wireless network among a plurality of electronic machines existing about each person. Different communication systems and wireless communication apparatuses have been stipulated by utilizing frequency bands unnecessary for licenses by supervisory offices, such as a 2.4 GHz band and a 5 GHz band.

As one of the standard specifications of wireless networks, IEEE (The Institute of Electrical and Electronics Engineers) 802.11 (e.g., refer to Non-patent Document 1), HiperLAN/2 (e.g., refer to Non-patent Document 2 or Non-patent Document 3), IEEE 802.15.3, Bluetooth communication and the like can be enumerated. The IEEE 802.11 standard has various wireless communication schemes such as the IEEE 802.11a standard and the IEEE 802.11b standard depending upon a difference of a wireless communication scheme and a frequency band in use.

In order to configure a local area network by using wireless technologies, a method is generally used in which one apparatus to be used as a control station called an “access point” or a “coordinator” is installed in an area and a network is formed under the collective control by the control station.

When information is transmitted from some communication apparatus in a wireless network having access points arranged therein, an access control method based on band reservation has been adopted widely by which a band necessary for transmitting the information is first reserved at an access point to use a transmission path without collision of information transmission with other communication apparatuses. Namely, synchronous wireless communication is performed by mutually synchronizing with communication apparatuses in the wireless network by arranging access points therein.

In a case where asynchronous communication is to be performed between communication apparatuses on the transmission side and reception side in a wireless communication system having access points, this wireless communication requires by all means wireless communication via an access point so that there arises the problem that a transmission path use efficiency is decreased, in specific, is halved.

As another method of configuring a wireless network, “ad-hoc communication” has been devised in which terminals perform wireless communication directly and asynchronously. It seems that the ad hoc communication in which arbitrary terminals can perform wireless communication directly without using a particular access point is suitable particularly for a small-scale wireless network configured by a relatively small number of clients positioned near each other.

In a working environment in which information equipment such as personal computers (PC) are prevailing and a number of apparatuses are mixedly used in an office, it can be supposed that a plurality of networks are configured in a superposed manner with scattered communication stations. In this state, if the wireless network uses a single channel, there is no room of recovering the situations that another system intrudes during communication and that the communication quality is degraded by interference or the like.

To avoid this, a conventional wireless network system generally adopts a method by which a plurality of frequency channels are prepared for coexistence of other networks and a communication operation starts by making a wireless communication apparatus serving as an access point select one frequency channel. For example, in a standard such as IEEE 802.11h, a system called “Dynamic Frequency Select (DFS)” for changing a channel dynamically has been examined.

The multi-channel communication scheme of this type can maintain a network operation and realize coexistence of other networks by switching a frequency channel to be used, when another system intrudes during communication or a communication quality is degraded by interference or the like.

For example, a high speed PAN system of IEEE 802.15.3 also prepares a plurality of frequency channels usable by the system and adopts an algorithm that after a power is turned on, a wireless communication apparatus selects a usable frequency channel by executing a scan operation for all usable channels in order to confirm whether or not there are devices which are transmitting a beacon signal as the Piconet Coordinator (PNC) around the wireless communication apparatus.

In an ad hoc network of a self-organized distribution type without relationship between a controlling station and a controlled station, resource management of frequency channels is important in order to. suppress as much as possible interference with nearby different wireless networks under operation. However, in order to change frequency channels used in the network at a time, a representative station called a coordinator or an access point is required to instruct a use channel to each terminal station. In other words, it is difficult to switch a frequency channel in the ad hoc network.

In HiperLAN/2 for example, a method of changing frequency channels at a time can be considered in order to selectively use a plurality of channels. For example, an AP (base station) as a central control station repetitively notifies a frequency channel change, and, at some timing, the AP and an MT (mobile station) connected to the AP switch the channels at a time. A judgment whether the channel is switched or not is determined initiatively by the AP. Information to be used for the judgment is collected by following a process procedure. In other words:
(1) upon an instruction from the AP, the connected MT temporarily suspends communication, scans other frequency channels to evaluate channel quality, and sends a result to the AP;
(2) upon an instruction from the AP, the AP temporarily stops the transmission on a broadcast channel, and the connected MT scans the frequency channel in present use, evaluates the channel quality and reports a result to the AP.

Bluetooth communication adopts a method by which a central control station called a master serving as a criterion performs random frequency hopping to utilize squarely each frequency channel. Existence of the central control station, that is, the master is essential for the network configuration and the central control station is used as the criterion of a frequency channel hopping pattern and synchronization of a time axis direction. If the master extinguishes, the network formed until then is once disconnected so that a process of selecting a new master is necessary.

Also in a wireless LAN system of the IEEE 802.11 series, since a network is formed by using the frequency channel initially set by an access point, it is difficult to configure an ad hoc network without disposing a base station. When communication with a wireless communication apparatus (terminal) covered by the AP operating at another frequency channel is to be performed, it is necessary to connect APs by wired LAN cables. Namely, if the APs by which terminals are covered are not connected, communication is not possible even if wireless communication apparatuses (terminals) physically existing adjacent to each other are covered by different APs.

Also in a high speed wireless PAN system of IEEE 802.15.3, although it is possible to initially scan all frequency channels and search a neighbor coordinator, if an operation starts once at a particular frequency channel, it is not possible to grasp the use state of other frequency channels. Therefore, even if a neighbor Piconet using a different frequency channel exists, communication with a wireless communication connected to the Piconet is impossible.

As above, the conventional methods require a complicated mechanism such as timings of frequency channel switching, a setup process to be realized by message exchange for starting a frequency channel switching operation through mutual synchronization of participating terminals, and an adjustment process to be used for determining frequency channel switching. It is also essential that a central control station, such as an AP in IEEE 802.11 and HiperLAN/2 and a master in Bluetooth communication, initiatively performing control exists for the methods. If the central control station such as an AP and a master extinguishes, some protocol process of selecting a substitute central control station or a manual setting change work is necessary, resulting in a problem that communication is intercepted during this process.

In addition, since the terminals are used at different areas, it seems that interference they receive will be different depending on the terminals. In this case, in a system in which all terminals move toward a common channel at a time, the common terminal may be an inconvenient one with heavy interference for a certain terminal.

For example, a wireless communication system has been proposed which determines a frequency channel by measuring not only interference of own channel but also interference of adjacent channels by using these channels (e.g., refer to Patent Document 1), this system realizing a multi-channel with involvement of a base station.

Moreover, a method in which a communication station specifies a traffic reception channel by transmitting beacons through the optimum channel for the communication station itself, that is, the local station, can be considered. However, there is a possibility that, even when the channel is the optimum channel for the local station, the channel is one under interference for a communication station receiving the beacons. For example, when a beacon transmission channel of one station is an interference channel of the other station or an unusable channel having deteriorated communication quality, these communication stations fall into a state of a deadlock in which the communication stations cannot eternally recognize mutual existence, even though the communication stations can perform communication with each other through the other channels.

For example, in the multi-channel communication system in which each communication station selects an optimum channel for itself, even if the interference which the communication stations receive differs depending on the area of the stations, it is expected that a channel evading the interference is selected.

However, the interference is a problem on the reception side while the transmission side selects the communication channel. Accordingly, the channel selected by a transmission terminal may be an optimum channel for a certain terminal and may be a channel with heavy interference for another reception terminal. In short, there still remains a question what is the best way for a transmission terminal to select a transmission channel.
[Patent Document 1] Japanese Patent Application Publication Hei 6-37762
[Non-Patent Document 1] International Standard ISO/IEC 8802-11:1999(E) ANSI/IEEE Std 802.11, 1999 Edition, Part II: Wireless LAN Medium Access Control (MAC) and Physical Layer (PHY) Specifications
[Non-Patent Document 2] ETSI Standard ETSI TS 101 761-1 V1.3.1 Broadband Radio Access Networks (BRAN); HIPERLAN Type 2; Data Link Control (DLC) Layer; Part 1: Basic Data Transport Functions
[Non-Patent Document 3] ETSI Standard ETSI TS 101-761-2 V1.3.1 Broadband Radio Access Network (BRAN); HIPERLAN Type 2; Data Link Control (DLC) Layer; Part 2: Radio Link Control (RLC) sublayer

### SUMMARY OF THE INVENTION

An object of the present invention is to provide an excellent wireless communication system, wireless communication apparatus, wireless communication method and computer program, which can properly configure a suitable ad hoc network without any interference between communication stations in a communication environment provided with a plurality of channels.

Another object of the present invention is to provide an excellent wireless communication system, wireless communication apparatus, wireless communication method and computer program, which can perform a channel access by effectively utilizing a plurality of frequency channels in a wireless network of a self-organized distribution type without relationship between a controlling station and a controlled station.

A further object of the present invention is to provide an excellent wireless communication system, wireless communication apparatus, wireless communication method and computer program, all capable of evading a deadlocked state, in which each communication station cannot recognize mutual existence, and capable of forming a self-organized distribution type multi-channel wireless network.

A further object of the present invention is to provide an excellent wireless communication system, wireless communication apparatus, wireless communication method and computer program, capable of forming a self-organized distribution type multi-channel wireless network in consideration of channel interference information on a reception side by each communication station.

The present invention is made in view of the above-described problem, and a first aspect of the present invention provides a system for forming a network for a plurality of wireless communication apparatuses without relationship between a controlling station and a controlled station in a self-organized manner in a communication environment provided with a plurality of channels, in which each communication station selects a channel from the plurality of channels on the basis of channel interference information in a neighbor station to perform communication.

The “system” used in this specification means a logical collection of a plurality of apparatuses (or functional modules realizing specific functions) and does not specifically refer to whether each apparatus or function module is accommodated in a single housing.

Herein, each communication station acquires communication quality regarding each of the plurality of channels and notifies channel quality information describing the communication quality of each channel in a beacon transmitted at a predetermined time interval or in other form in order to consider the channel quality information with each other.

Each communication station acquires an average level of the interference which the neighbor stations receive for each channel, and then, a channel with the lowest average interference level is determined as the transmission channel.

In this case, by weighting the interference of a neighbor station with a high priority for the local station to obtain a weighted average for each channel, a channel with less interference for the prioritized neighbor station for the local station is selected as the transmission channel. The priority given to the neighbor station herein can be determined depending on an amount of data transmitted thereto from the local station during a predetermined period, for example.

Furthermore, in a case where a channel receiving too heavy interference to restore a signal in a certain neighbor station exists, a weight larger than the interference level of the channel receiving the heavy interference in the neighbor station may be added to obtain the weighted average.

In addition, a second aspect of the present invention provides a computer program written in a computer readable format so as to execute a processing for performing wireless communication on a computer system in a self-organized distributed manner in a wireless communication environment provided with a plurality of channels, comprising: a communication channel setting step for setting a transmission channel for a transmission signal of a local station; and a control step for controlling a communication operation on the channel set in the communication channel setting step, in which, in the communication channel setting step, the channel is selected from the plurality of channels on the basis of channel interference information in a neighbor station.

The computer program according to the second aspect of the present invention defines a computer program written in a computer readable format so as to realize a predetermined process on the computer system. In other words, as the computer program according to the second aspect of the present invention is installed in the computer system, a cooperative process is presented on the computer system to operate it as a wireless communication apparatus. A plurality of wireless communication apparatuses are activated to configure a wireless network so that similar operations and effects to those of the wireless communication system according the first aspect of the present invention can be obtained.

According to the present invention, it is possible to provide an excellent wireless communication system, wireless communication apparatus, wireless communication method and computer program, all capable of effectively utilizing a plurality of frequency channels to perform a channel access in a self-organized distribution type wireless network without relationship between a controlling station and a controlled station.

Moreover, according to the present invention, it is possible to provide an excellent wireless communication system, wireless communication apparatus, wireless communication method and computer program, all capable of evading a deadlocked state in which each communication station cannot recognize mutual existence, and capable of forming a self-organized distribution type multi-channel wireless network.

In addition, according to the present invention, it is possible to provide an excellent wireless communication system, wireless communication apparatus, wireless communication method and computer program, capable of forming a self-organized distribution type multi-channel wireless network in consideration of channel interference information on a reception side by each communication station.

According to the present invention, each communication station takes channel interference information in the neighbor station into consideration, obtains an average interference level the neighbor station receives for each channel, and determines a channels with the lowest average interference level as a transmission channel. In this case, by weighting the interference of a neighbor station with a high priority for the local station to obtain a weighted average for each channel, a channel with less interference for the prioritized neighbor station for the local station is selected as the transmission channel. As a result, throughput of the entire system is improved.

For example, by adding a weight to each neighbor station in accordance with an amount of transmission data during a predetermined period to perform a weighted average calculation, a transmission destination receiving more transmission data is assigned with a channel with less interference. As a result, the more the transmission data amount is, the less error and retransmission occur. Accordingly, the data communication can be performed using a faster modulation speed and the throughput of the entire system is improved.

Furthermore, in a case where a channel receiving too heavy interference to restore a signal in a certain neighbor station, a larger weight may be added to the channel to obtain the weighted average. Therefore, even in a terminal with a lower priority, it is possible to evade the interference channel with priority to avoid disconnection from the network.

Other objects, features and advantages of the present invention will become apparent from the preferred embodiments of the present invention to be described later and the detailed description given in conjunction with the accompanying drawings.

### BRIEF DESCRIPTION OF THE DRAWINGS

FIG. 1 is an example of an arrangement of communication apparatuses constituting a wireless communication system according to an embodiment of the present invention;

FIG. 2 is a schematic view of a functional structure of a wireless communication apparatus operating as a communication station in the wireless network according to the embodiment of the present invention.

FIG. 3 is a view showing a beacon transmission procedure at each communication station according to the embodiment;

FIG. 4 is a view showing an example of beacon transmission timings on one channel;

FIG. 5 is a view showing definition of a packet interval;

FIG. 6 is a view showing how priority is assigned to a station transmitting a beacon;

FIG. 7 is a view showing a structure of a transmission frame period (T_SF).

FIG. 8 is a view showing a structural example of a beacon signal format;

FIG. 9 is a view showing a description example of NBOI in a case where the number of channels used is one.

FIG. 10 is a view showing how a new entry station arranges own beacon transmission timing on a certain frequency channel in accordance with the description in NBOI, while evading a collision with already existing beacons;

FIG. 11 is a view showing a state where a new entry station sets beacon transmission timing substantially at the middle of a beacon interval.

FIG. 12 is a view schematically showing a structure of a wireless communication system of a multi-channel structure;

FIG. 13 is a view showing a state where two communication stations are arranged in an interference environment;

FIG. 14 is a view showing a state where only four communication stations A-D are present in a communication range and a communication station A selects a transmission channel;

FIG. 15 is a flowchart showing processing steps, in a case where a channel receiving too heavy interference to restore a signal in a certain neighbor station exists, in a communication station for adding a larger weight to the channel to obtain a weighted average;

FIG. 16 is a view showing a state where each of the communication stations A-D arranges the beacon transmission timing on each channel in a multi-channel communication system composed of four channels of CH 1 to CH 4;

FIG. 17 is a view showing beacon position information in a condition of beacon transmission time and relative channel arrangement as shown in FIG. 16;

FIG. 18 is a view showing an example of beacon arrangement of each communication station on multiple channels.

### DESCRIPTION OF PREFERRED EMBODIMENTS

The preferred embodiments of the present invention will be described in detail with reference to the drawings.

A. System Configuration

Communication transmission paths assumed in the present invention are wireless, and a network is configured among a plurality of communication stations by using transmission media constituted of a plurality of frequency channels. Communication assumed in the present invention is traffics of a storage switch type, and information is transferred in a unit of a packet.

A wireless network system according to the present invention has a self-organized distribution type system structure not disposing a coordinator, and executes a transmission control effectively utilizing a plurality of channels by using a transmission (MAC) frame having a loosely synchronized time division multiple access structure. Each communication station can execute ad hoc communication for direct and asynchronous information transmission in accordance with an access procedure based on Carrier Sense Multiple Access (CSMA).

In this way, in the wireless communication system not disposing a controlling station as described above, that is, in the system without relationship between a controlling station and a controlled station, each communication station notifies beacon information to make another communication station in a neighbor area (i.e., in a communication range) know the existence of own communication station, and informs of a network configuration. A communication station newly entering in a communication range of some communication station can detect that it entered the communication range, by receiving a beacon signal, and can know the network configuration by analyzing information written in the beacon. Since the communication station transmits a beacon at the start of a transmission frame period, the transmission frame period at each channel used by each communication station is defined by a beacon interval.

In the multi-channel communication environment, in a case where each communication apparatus carries out beacon transmission only on a specific channel, there is a problem that a communication station which cannot transmit a beacon may appear. For example, in a case where a communication station selects a beacon transmission channel on the basis of a criterion for a station, for example, whether or not a target channel provides good communication quality for the local station, there may be a case that an optimum channel for the local station is a channel with interference for a communication station receiving the beacon. Although these communication stations can communicate on the other channel, they will fall into a deadlocked state in which each communication station cannot recognize mutual existence eternally.

For example, it is assumed that each wireless communication apparatus arbitrarily determines one of usable channel as a criterion channel and a beacon signal is notified only on the criterion channel to define a predetermined transmission frame period. The criterion channel is selected among multiple channels on the basis of a criterion for a local station, for example, whether or not a target channel provides good communication quality for the local station. In such a case, there is a possibility that an optimum channel for the local station is a channel under interference for another communication station receiving a beacon.

In view of the above situation, in the present embodiment, each wireless communication apparatus grasps information of a neighbor station and a neighbor environmental condition to select appropriate communication channel on the basis of a consideration result of channel interference information on a reception side in a self-organized manner. As a result, a deadlocked condition between the communication stations can be evaded. The details of the construction will be described later.

The process to be executed at each communication station to be described hereunder is fundamentally a process to be executed by all communication stations participating in the ad hoc network of the present invention. However, in some cases, not all the communication stations constituting the network execute the process to be described hereunder.

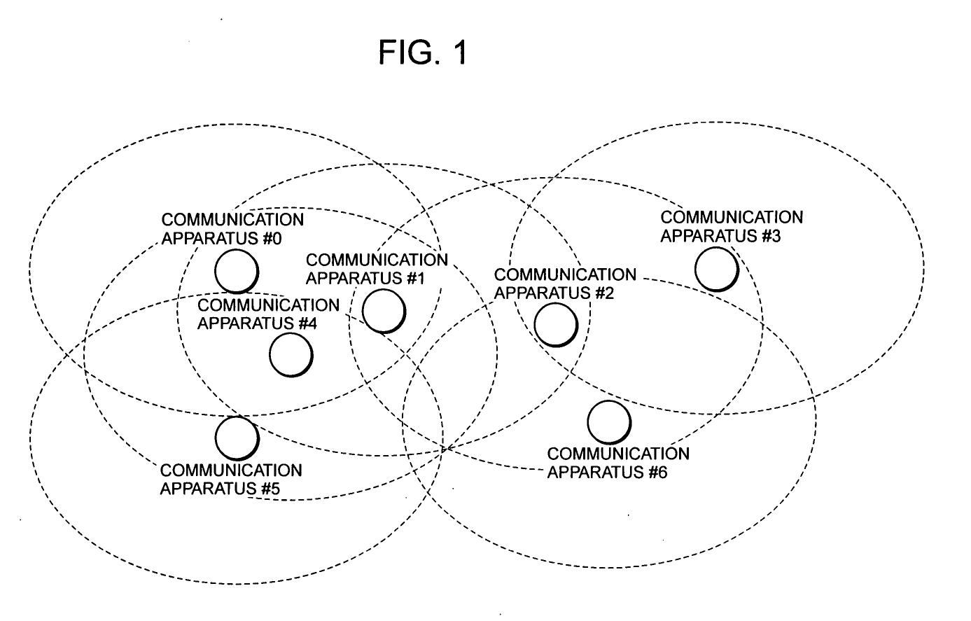

FIG. 1 shows an example of the arrangement of communication apparatuses constituting a wireless communication system according to a preferred embodiment of the present invention. In this wireless communication system, a particular control station is not disposed and each communication apparatus operates in a self-organized and distributed manner to configure the ad hoc network. FIG. 1 shows the state that communication apparatuses #0 to #6 are distributed in the same space.

A communication range of each communication apparatus is indicated by a broken line in FIG. 1, and defined as not only a range in which communication with other communication apparatuses are possible but also a range that a signal which the local station itself transmitted interferes. Namely, the communication apparatus #0 is in a range capable of communicating with the neighbor communication apparatuses #1 and #4, the communication apparatus #1 is in a range capable of communicating with the neighbor communication apparatuses #0, #2 and #4, the communication apparatus #2 is in a range capable of communicating with the neighbor communication apparatuses #1, #3 and #6, the communication apparatus #3 is in a range capable of communicating with the neighbor communication apparatus #2, the communication apparatus #4 is in a range capable of communicating with the neighbor communication apparatuses #0, #1 and #5, the communication apparatus #5 is in a range capable of communicating with the neighbor communication apparatus #4, and the communication apparatus #6 is in a range capable of communicating with the neighbor communication apparatus #2.

While communication is performed between particular communication apparatuses, there is a communication apparatus, i.e., a “hidden terminal” which one partner communication apparatus can hear but another partner communication apparatus cannot hear.

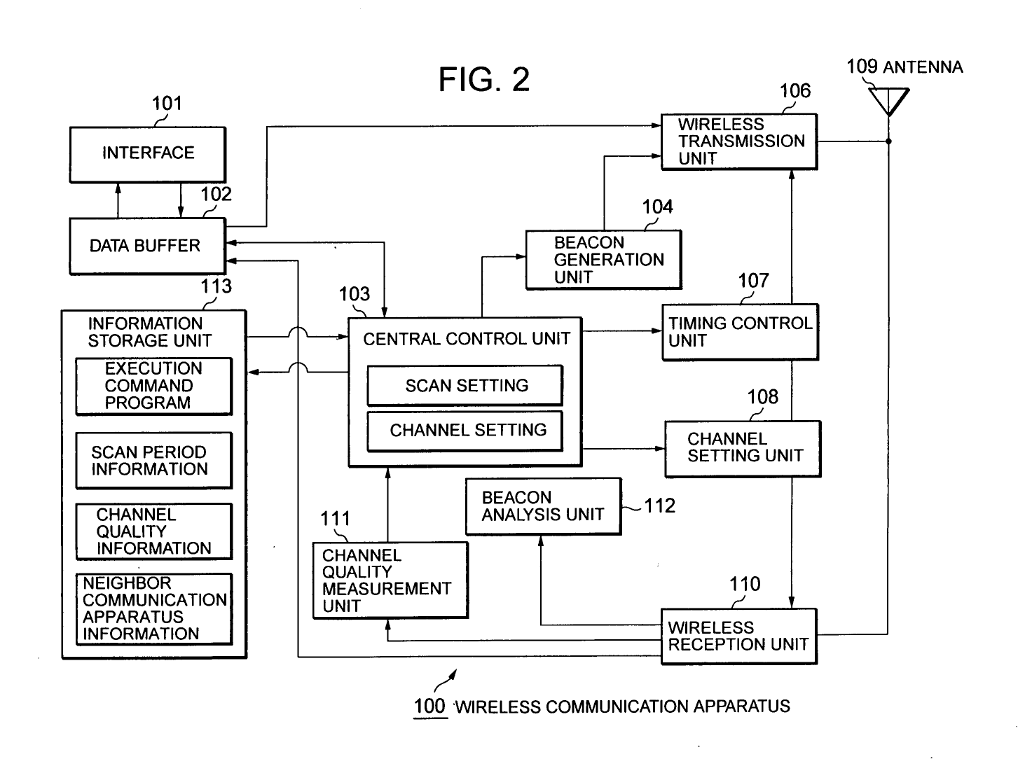

FIG. 2 is a schematic diagram of a functional structure of a wireless communication apparatus operating as a communication station in the wireless network according to a preferred embodiment of the present invention. The wireless communication apparatus shown in the figure can form a self-organized distributed network without interfering another wireless system by effectively performing a channel access in the same wireless system.

As shown in the figure, a wireless communication apparatus 100 is constituted of an interface 101, a data buffer 102, a central control unit 103, a beacon generation unit 104, a wireless transmission unit 106, a timing control unit 107, a channel setting unit 108, an antenna 109, a wireless reception unit 110, a channel quality measurement unit 111, a beacon analysis unit 112 and an information storage unit 113.

The interface 101 exchanges various information with an external apparatus (e.g., a personal computer (not shown) or the like) connected to the wireless communication apparatus 100.

The data buffer 102 is used for temporarily storing data sent from an apparatus connected via the interface 101 or data received via a wireless transmission path, before the data is sent out via the interface 101.

The central control unit 103 collectively manages a series of information transmission/reception processes at the wireless communication apparatus 100 and performs an access control of each transmission path (scan setting, channel setting and the like in multiple channels).

The beacon generation unit 104 generates a beacon signal to be periodically exchanged with a neighbor wireless communication apparatus. In order for the wireless communication apparatus 100 to run the wireless network, own beacon transmission slot position of each channel, own reception slot position of each channel, a reception slot position of a beacon from a neighbor communication apparatus of each channel, and own scan operation period of each channel are stipulated. This information is stored in the information storage unit 113 and written in the beacon signal to notify it to a neighbor wireless communication apparatus. Moreover, in the present embodiment, channel quality information regarding communication quality of each channel measured in the local station and, further, channel quality information fetched from a beacon signal of a neighbor station are described in a beacon. The structure of a beacon signal will be later described. Since the wireless communication apparatus 100 transmits a beacon at the start of a transmission frame period, the transmission frame period of each channel used by the wireless communication apparatus 100 is defined by a beacon interval.

The wireless transmission unit 106 performs a predetermined modulation process in order to wirelessly transmit data temporarily stored in the data buffer 102 and a beacon signal.

The antenna 109 transmits signals through a selected frequency channel to another wireless communication apparatus, or collects signals transmitted from other wireless communication apparatus. The present embodiment is configured to have a single antenna and not to perform transmission and reception parallely. Moreover, the embodiment is configured not to be able to handle a plurality of frequency channels at the same time.

The wireless reception unit 110 executes a process of receiving a signal of information and beacon sent from another wireless communication apparatus at a predetermined time. As a wireless transmission/reception method for the wireless transmission unit 106 and the wireless reception unit 110, for example, various communication methods suitable for relatively near distance communication applicable to a wireless LAN may be applied. Specifically, a UWB (Ultra Wide Band) method, an OFDM (Orthogonal Frequency Division Multiplexing) method, a CDMA (Code Division Multiple Access) method or the like can be adopted.

The channel quality measurement unit 111 analyzes a signal received from a neighbor station to measure communication quality of each channel in the local station and store a measurement result in the information storage unit 113 as channel quality information. For example, in the physical layer protocol (Phy), it is possible to measure the communication quality of a channel in a way as described below.
(1) Measure an interference level in accordance with a measurement result of a reception signal level at the time of no signal.
(2) Measure an interference level based on an error rate in each channel.

The channel setting unit 108 selects a channel used at the time when a wireless signal of a multi-channel type is actually transmitted and received. In the present embodiment, an average level of the interference that the neighbor stations receive is obtained for each channel, and a channel with the lowest average interference level is determined as the transmission channel.

Herein, by weighting the interference of a neighbor station with a high priority for the local station to obtain a weighted average for each channel, a channel with less interference for the prioritized neighbor station for the local station is selected as the transmission channel. As a result, throughput of the entire system is improved. For example, by adding weight to each neighbor station in accordance with an amount of transmission data during a predetermined period to perform a weighted average calculation, a transmission destination receiving more transmission data is assigned with a channel with less interference. As a result, the more the transmission data is, the less error and retransmission occur. Accordingly, the data communication can be performed using a faster modulation speed so that the throughput of the entire system is improved. The details of the channel setting procedures at the time of transmitting data and a beacon will be later given.

The timing control unit 107 controls timing for transmitting and receiving a wireless signal on the channel set in channel setting unit 108. For example, the timing control unit 107 controls its own beacon transmission timing at the head of a transmission frame period in a beacon transmission channel, beacon reception timing from other communication apparatus in each channel, data transmission/reception timing to and from the other communication apparatus, a scan operation period in each channel, and the like.

The beacon analysis unit 112 analyzes a beacon signal which was received from a neighbor station to analyze existence and the like of another neighbor wireless communication apparatus. For example, information such as the beacon reception timing of a neighbor station, initial channel information, neighbor beacon reception timing is stored to the information storage unit 113 as neighbor apparatus information. In addition, the channel quality information described in a beacon is also stored in the information storage unit 113.

The information storage unit 113 stores execution procedure commands (programs for performing scan setting, -channel setting and the like) of a series of access control operations and the like to executed by the central control unit 103, beacon transmission timing of other communication stations, channel quality information, neighbor apparatus information and the like.

B. Access Operation on a Channel

In this embodiment, in the communication environment provided with a plurality of channels and without relationship between a controlling station and a controlled station, the wireless communication apparatus 100 operating as a communication station performs a transmission control by effectively using a plurality of channels by a transmission (MAC) frame having a loosely synchronized time division multiplex access structure or a communication operation such as a random access based on CSMA/CA.

Each communication station notifies beacon information on a specific channel at a predetermined time interval to let another neighbor communication station (i.e., in a communication range) know the existence of the communication station, and informs of a network configuration. A communication station newly entering in a communication range of a certain communication station can detect that it entered the communication range, by receiving a beacon signal, and can know the network configuration by analyzing information written in the beacon. The channel setting unit 108 sets a beacon transmission channel. The channel setting unit 108 obtains an average interference level that the neighbor station receives for each channel, and determines a channel with the lowest average interference level as a transmission channel so that more neighbor stations can hear the beacon signal.

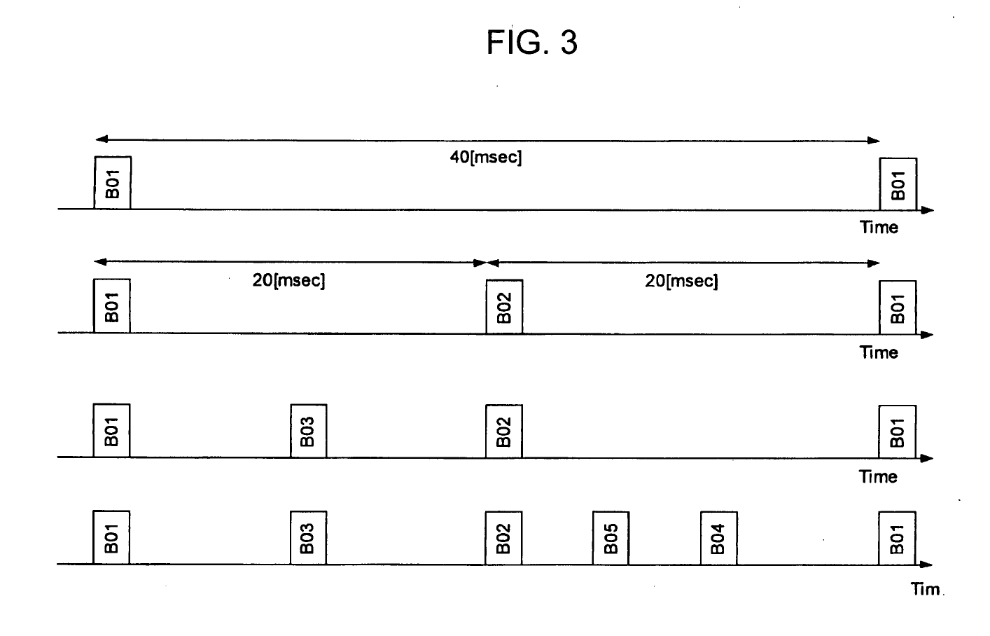

A beacon transmission procedure at each communication station according to this embodiment will be described with reference to FIG. 3. It is noted that a case where beacons of each communication station are arranged on a single channel will be explained first herein.

Assuming that information capable of being transmitted by a beacon is 100 bytes, the time taken to transmit it is 18 μs. Since one transmission is executed every 40 ms, a media occupying factor by a beacon at each communication station is as sufficiently small as one 2222-nd.

Each communication station synchronizes loosely while hearing a beacon transmitted in a neighboring area. When a new communication station appears, the new communication station sets own beacon transmission timing so as not to collide with the beacon transmission timings of already existing communication stations.

If there is no communication station in the neighboring area, a communication station 01 can start transmitting a beacon. A beacon transmission interval is 40 ms (described already). In an example of the uppermost stage shown in FIG. 2, B01 indicates the beacon transmitted from the communication station 01.

A communication station newly entering the communication range thereafter sets own beacon transmission timing so as not to collide with the arrangement of already existing beacons. In this case, since each communication station acquires a transmission guaranteed period (TGP) immediately after beacon transmission, it is preferable that beacon transmission timings of respective communication stations are not congested but are uniformly distributed on a single channel from the viewpoint of a transmission efficiency. Therefore, in this embodiment, fundamentally beacon transmission starts generally at the middle of the longest beacon interval in the range where own station can hear it.

It is assumed, for example, that a new communication station 02 appears on a channel that only the communication station 01 exists as shown in the uppermost stage of FIG. 3. In this case, the communication station 02 receives the beacon from the communication station 01 to recognize its existence and a beacon position, and as shown at the second stage of FIG. 3, sets own beacon transmission timing generally at the middle of the beacon interval of the communication station 01 to start beacon transmission.

It is assumed that another new communication station 03 appears. In this case, the communication station 03 receives at least one of the beacons transmitted from the communication station 01 and the communication station 02 to recognize the existence of these already existing communication stations. As shown at the third stage of FIG. 3, transmission starts generally at the middle of the interval of beacons transmitted from the communication station 01 and the communication station 02.

Subsequently, each time a new communication station participates in a neighboring area in accordance with the similar algorithm, the beacon interval is narrowed. For example, as shown at the lowermost stage of FIG. 3, a communication station 04 appearing next sets the beacon transmission timing at generally the middle of the beacon interval set by the communication station 02 and the communication station 01, and a communication station 05 appearing second next sets the beacon transmission timing at generally the middle of the beacon interval set by the communication station 02 and communication station 04.

A minimum beacon interval Bmin is defined so that the band (transmission frame period) is not made in excess of beacons. It is not allowed that two or more beacon transmission timings are set in Bmin. For example, if the minimum beacon interval Bmin is defined to be 2.5 ms in the transmission frame period of 40 ms, sixteen communication stations can be accommodated at a maximum in the range where radio waves can reach.

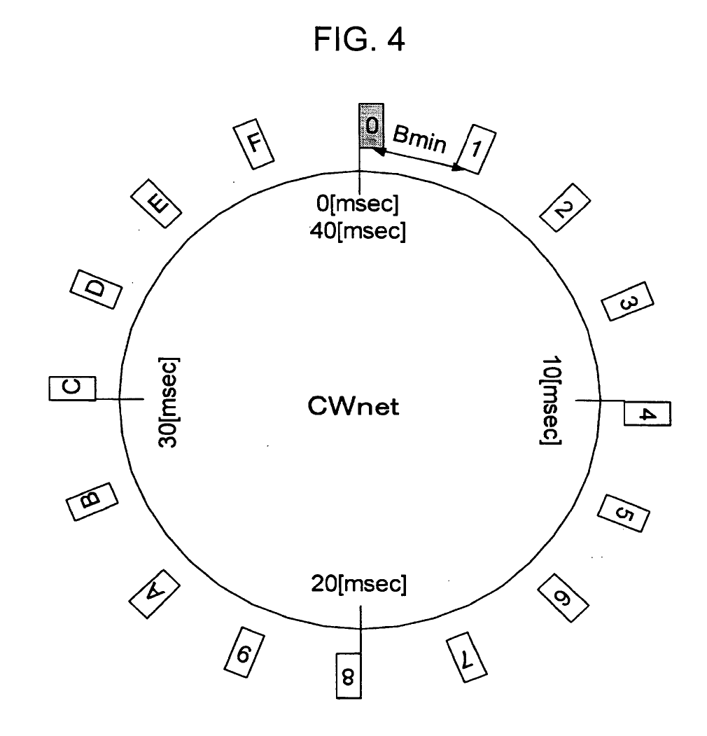

FIG. 4 shows an example of beacon transmission timings in a single channel. In this example shown in FIG. 4, a lapse of time in the transmission frame period of 40 ms is drawn like a clock whose hands move on a ring in a clockwise direction.

In the example shown in FIG. 4, sixteen communication stations 0 to F constitute nodes of the network. As described with reference to FIG. 3, it is assumed that beacons are disposed in accordance with the algorithm that beacon transmission timings of new entry stations are sequentially set generally at the middle of a beacon interval set by already existing communication stations. If Bmin is set to 2.5 ms, communication stations larger in number than that defined by Bmin cannot participate in the network.

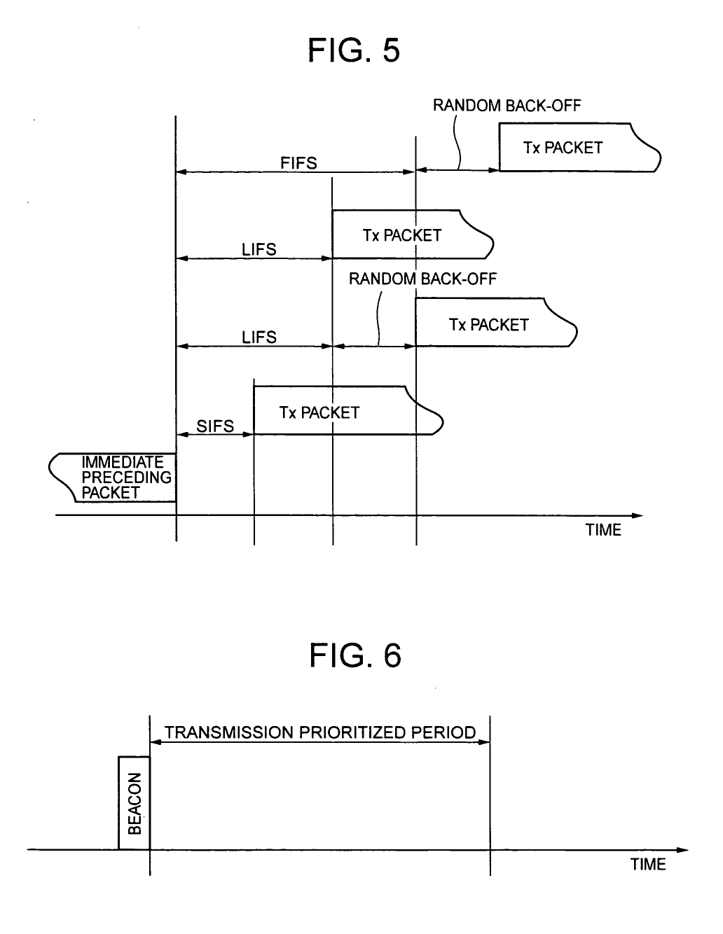

Similar to a case of the IEEE 802.11 method or the like, also in this embodiment a plurality of packet intervals are defined. The definition of a packet interval will be described with reference to FIG. 5. Defined for the packet interval are Short Inter Frame Space (SIFS) and Long Inter Frame Space (LIFS). Only those packets given a higher priority are allowed to be transmitted at the SIFS packet interval, and the other packets are allowed to be transmitted after it is confirmed that media are cleared by a packet interval of LIFS+a random back-off whose value is determined randomly. As a method of calculating a random back-off value, a method known in already existing techniques may be applied.

Also in this embodiment, in addition to the above-described packet intervals “SIFS” and “LIFS+back-off”, the “LIFS” and “FIFS+back-off” (FIFS: Far Inter Frame Space” are defined. Although the “SIFS” and “LIFS+back-off” are generally applied, in the time period while a certain communication station is given a transmission priority, other stations use the packet interval “FIFS+back-off” and the station given the priority uses the packet interval SIFS or LIFS.

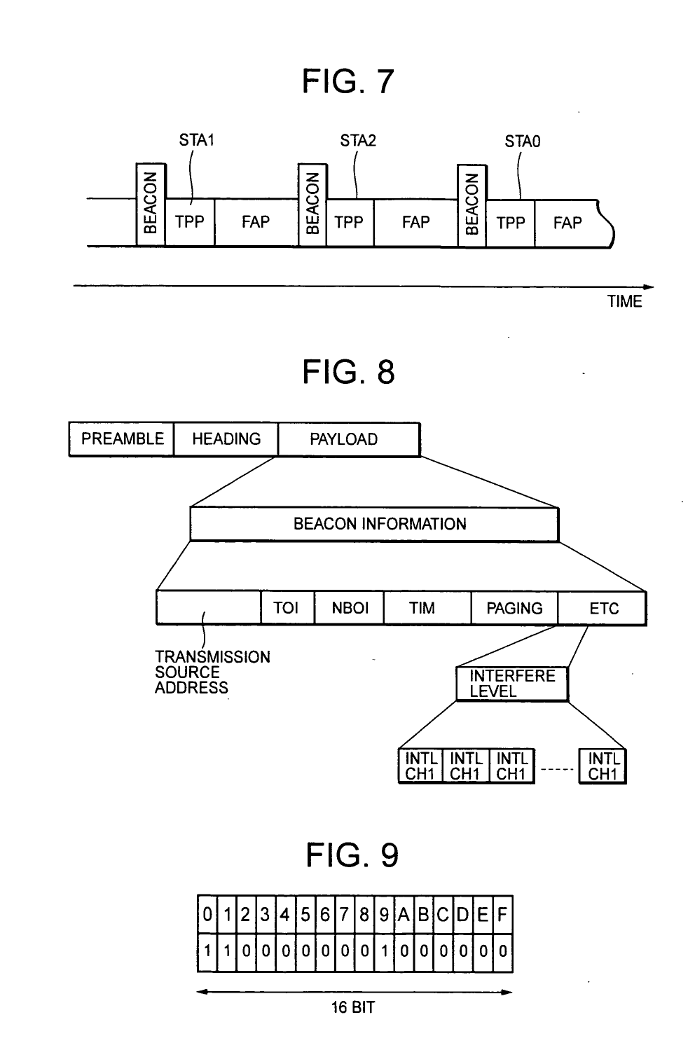

Although each communication station transmits beacons at a constant interval, the station transmitted the beacon is assigned a transmission priority during some period after the beacon is transmitted. FIG. 6 shows how the priority is assigned to the station transmitted a beacon. In the present specification, this priority period is defined as Transmission Prioritized Period (TPP). In addition, the period other than TPP is defined as Fairly Access Period (FAP), and communication is performed between communication stations according to the CSMA/CA method. FIG. 7 shows a structure of a transmission frame period (T_SF). As shown in FIG. 7, after the communication station transmits a beacon, TPP is assigned to the communication station transmitted the beacon, and after the lapse of time corresponding to the length of TPP, FAP enters which is terminated when a next communication station transmits a beacon. In this example, although TPP starts immediately after the beacon is transmitted, the invention is not limited to this. For example, the start time of TPP may be set to a relative position (time) from the beacon transmission time.

The packet interval on one channel is studied again as in the following. Each communication station executes transmission at the interval of LIFS+back-off in the FAP period. Beacon and packet transmissions in TPP of the local station are permitted at the SIFS interval. Packet transmission in TPP of own station is also permitted at the LIFS interval. Packet transmission in TPP of another station is performed at the interval of FIFS+back-off. In the IEEE 802.11 scheme, although the packet interval is always FIFS+back-off, in the structure of the present embodiment, the interval can be shortened so that a packet can be transmitted more efficiently.

In the above description, although only the communication station in TPP is assigned the prioritized transmission privilege, the prioritized transmission privilege is also assigned to a communication station called by the communication station in TPP. In TPP, transmission is fundamentally made preferentially. However, if there is no information to be transmitted from the local communication station and another communication station has information to be transmitted to the local communication station, then a Paging message or a Polling message may be sent to the “other station”.

On the contrary, if the local station has no information to be transmitted although the beacon was transmitted and the local station does not know that another station has information to be transmitted to the local station, then this own station carries out no communication operation and does not transmit any information and discards the transmission priority given in TPP. The other station starts transmission after the lapse of LIFS+back-off or FIFS+back-off even in this time period.

By considering the structure that TPP follows immediately after a beacon is transmitted as shown in FIG. 7, it is more preferable in terms of a transmission efficiency that the beacon transmission timings of the respective communication stations are not congested but are uniformly distributed in the transmission frame period. Therefore, in this embodiment, fundamentally beacon transmission starts generally at the middle of the longest beacon interval in the range where the local station can hear it. It is of course there is a method by which beacon transmission timings of respective communication stations are arranged in a concentrated manner, and during the remaining transmission frame period, the reception operation is stopped to reduce the consumption power.

FIG. 8 shows an example of the structure of a beacon signal format. As shown in FIG. 8, a beacon signal has a preamble for notifying the existence of the signal, followed by a heading and a payload field PSDU. The heading field describes the information that the packet is the beacon. Information desired to be notified by the beacon, as follows, is described in the PSDU.
TX.ADDR: a MAC address of a transmission station (TX)
TOI: a TBTT offset indicator (TBTT Offset Indicator)
NBOI: neighbor beacon offset information
TIM: a traffic indication map
PAGE: paging

TIM is annunciation information representative of that this communication station has presently information to be destined to which communication station. By referring to TIM, a reception station can recognize that the information is required to be received. Moreover, Paging is a field indicating that the field is scheduled to be transmitted in the TPP immediately after the time among the reception stations inserted in the TIM. A station specified by the field should prepare the reception at the TPP. The other field (ETC field) is also prepared. The ETC field may include a field describing the degree of receiving interference, i.e., interference level (IntLCH), as channel quality information in each of the prepared frequency channels. An interference level of each channel is obtained on the basis of a measurement result of a reception signal level at the time of no signal or of an error rate at the time of communication on a channel (already described).

NBOI is information describing a beacon arrangement of a neighbor communication station in a transmission frame on a channel. In this embodiment, sixteen beacons can be disposed at each channel and in the transmission frame period at a maximum. Therefore, NBOI is structured as a 16-bit length field corresponding to each beacon position, and the information of the arrangement of beacons capable of being received is written in a bit map format. As a standard, 1 is written at a bit corresponding to a relative position (off-set) of beacon reception timing from each communication station, by using the beacon transmission timing of own station. A bit position corresponding to the relative position of timing when a beacon is not received remains unchanged to 0.

FIG. 9 shows a description example of NBOI in a case where the number of using channel is one. In the example shown in FIG. 9, the NBOI field notifies that a communication station 0 shown in FIG. 3 “can receive beacons from a communication station 1 and a communication station 9”. A lowermost bit in the NBOI field is assigned to the beacon transmission position of the local station. Referring to the position as a criterion, assignment to a bit corresponding to the relative position (offset) of a receivable beacon of the neighbor station is carried out as in: if the beacon has been already received, a mark is assigned to the bit, and if not, a space is assigned. A mark may be assigned to the bit corresponding to the timing that the beacon is not still received, for the purposes other than the above description. In the present embodiment, the NBOI information describing the beacon arrangement regarding each available frequency channel is required and description regarding this point will be made later.

After mutually receiving beacon signals on a certain channel, in accordance with NBOI contained in each beacon signal, each communication station can arrange own beacon transmission timing so as to avoid collision of the beacons on each of usable frequency channels and can detect the beacon reception timing from a neighbor station.

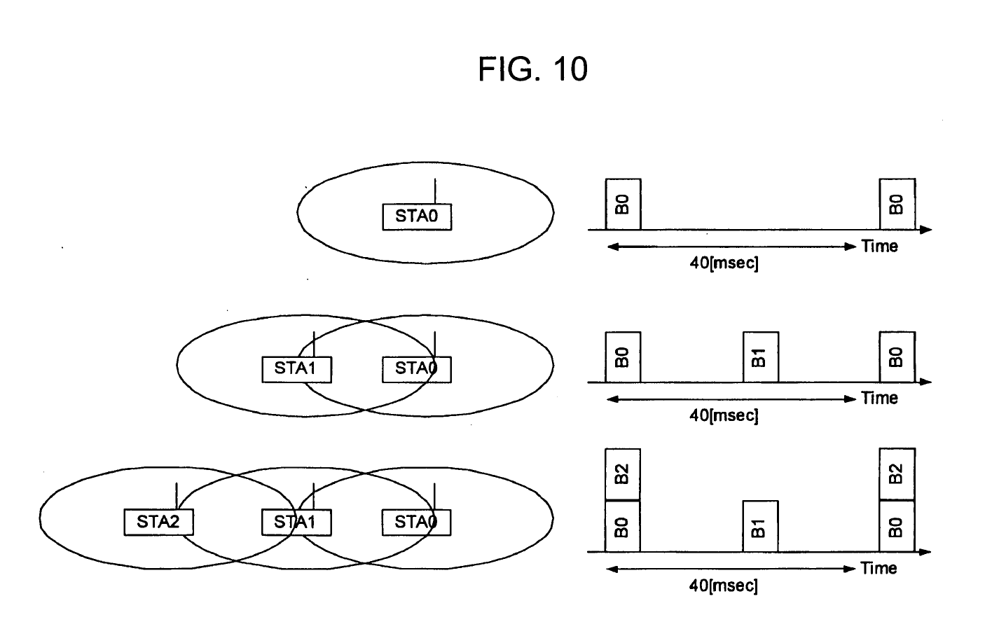

FIG. 10 shows how a newly participating station arranges own beacon transmission timing on a certain frequency channel in accordance with the description in NBOI, while avoiding a collision with already existing beacons. Each stage shown in FIG. 10 indicates an entry state of communication stations STA0 to STA2. The left side of each stage indicates an arrangement state of each communication station and the right side indicates an arrangement of beacons transmitted from the stations.

The uppermost stage shown in FIG. 10 shows a case where only the communication station STA0 exists. STA0 tries to receive a beacon but cannot receive it so that it sets proper beacon transmission timing and can start transmitting a beacon when this timing comes. A beacon is transmitted every 40 ms (transmission frame). All bits in the NBOI field described in the beacon transmitted from STA0 are 0.

The middle stage shown in FIG. 10 shows that STA1 enters within the communication range of the communication station STA0. STA1 tries to receive a beacon and receives the beacon from STA0. Since all bits in the NBOI field other than the bit corresponding to own transmission timing are 0, own beacon transmitting timing is set substantially at the middle of the beacon interval of STA0 in accordance with the above-described process procedure.

In the NBOI field of the beacon transmitted from STA1, 1 is set to the bit representative of own transmission timing and the bit representative of a reception timing of the beacon from STA0, and 0 is set to all other bits. As STA0 recognizes the beacon from STA1, 1 is set to the corresponding bit position of the NBOI field.

The lowermost stage shown in FIG. 10 shows that STA2 enters the communication range of the communication station STA1. In the example shown in FIG. 10, STA0 is a hidden terminal relative to STA2. Therefore, STA2 cannot recognize that STA1 receives the beacon from STA0 so that as shown in the right side, there is a possibility that STA2 transmits the beacon at the same timings as those of STA0 and a collision occurs.

The NBOI field is used to avoid this phenomenon. In the NBOI field of the beacon of STA1, 1 is set to the bit representative of own transmission timing and the bit representative of the beacon transmission timing of STA0. Although STA2 cannot directly receive the beacon transmitted from the hidden terminal STA0, STA2 can recognize the beacon transmission timing of STA0 from the beacon received from STA1 and can avoid the beacon transmission at this timing.

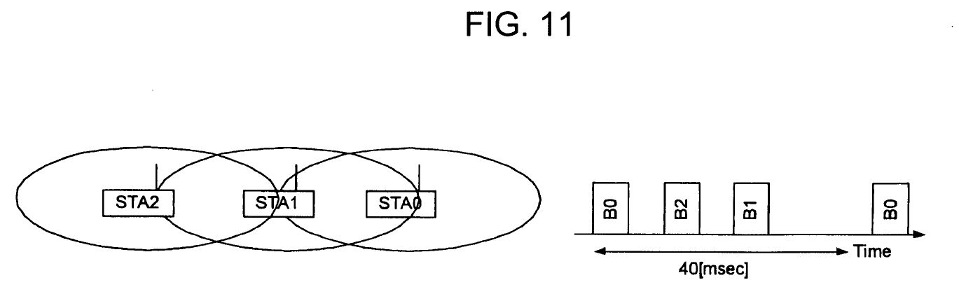

As shown in FIG. 11, STA2 sets the beacon transmission timing substantially at the middle of the beacon interval of STA0 and STA1. Obviously, in NBOI of the beacon transmitted from STA2, 1 is set to the bits representative of the beacon transmission timings of STA2 and STA1. With the beacon collision avoiding function based upon the description in the NBOI field, the beacon position of the hidden terminal, i.e., the neighbor station that is two stations ahead can be grasped and a beacon collision can be avoided.

C. Setting Procedure of Transmission Channel

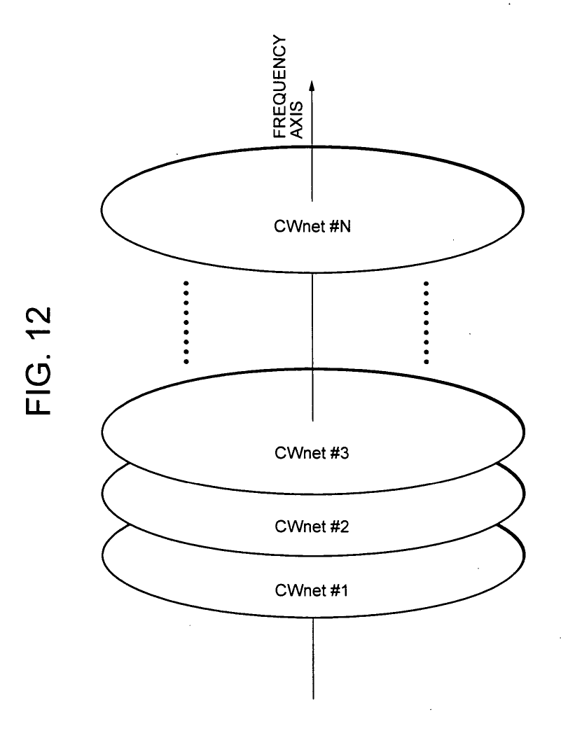

As described above, in a self-organized distribution type wireless communication system, each communication station notifies beacon information in the transmission frame period and beacon signals from other stations are scanned so that the network configuration on a single channel can be recognized. In a case of the multi-channel self-organized distribution type network of this embodiment, however, the transmission frames such as the one shown in FIG. 4 corresponding in number to the number of usable channels are disposed on the frequency axis (refer to FIG. 12). Therefore, each communication station cannot receive a beacon unless it moves to the same channel at the beacon transmission timing of another communication station. Thus, it is difficult to know the network configuration in all channels.

Moreover, it may be possible that a channel which is an optimum one for a communication channel is one under interference for the other station being a communication partner. For example, when a beacon transmission channel of one station is an interference channel of the other station or an unusable channel having deteriorated communication quality, these communication stations fall into a state of a deadlock in which the communication stations cannot eternally recognize mutual existence, even though the communication stations can perform communication with each other through the other channels.

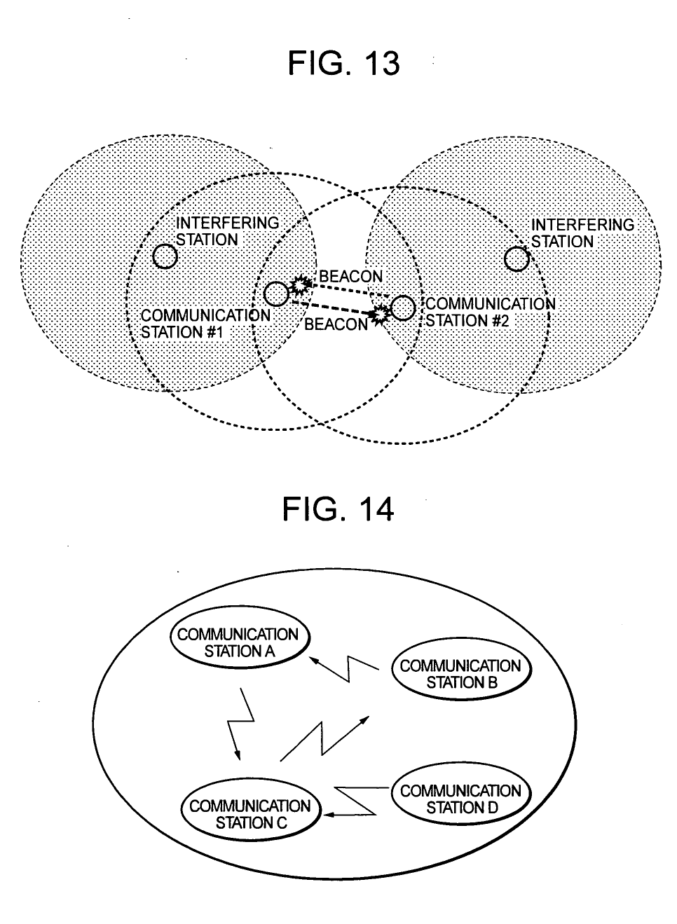

As described above, it is supposed that each communication station is provided with a single antenna and does not perform transmission and reception parallely, and that it is not possible to handle a plurality of frequency channels at the same time. Hereupon, a state in which two communication stations are arranged in an interference environment as shown in FIG. 13 is examined.

A communication station #1 is arranged in a communication environment in which the communication station #1 is under interference in a channel CH1 but is not under interference in a channel CH2 (being clear), which environment is designated by oblique lines inclined to the left. The communication station #1 sets the channel CH2 as a beacon transmission channel of the local station. Moreover, a communication station #2 is arranged in a communication environment in which the communication station #2 is under interference in the channel CH2 but is not under interference in the channel CH1 (being clear), which environment is designated by oblique lines inclined to the right. The communication station #2 sets the channel CH1 as the beacon transmission channel of the local station. Because the communication stations #1 and #2 transmit beacons through mutual interference channels in this situation, the communication stations #1 and #2 cannot recognize the mutual existence eternally.

In the multi-channel communication system in which each communication station selects an optimum channel for itself, even if the interference that the communication stations receive differs depending on the area of the stations, it is expected that a channel preventing the interference is selected. However, the interference is a problem on the reception side while the transmission side selects the communication channel. Accordingly, the channel selected by a transmission terminal may be an optimum channel for a certain terminal and may be a channel with heavy interference for another reception terminal.

According to the present embodiment, channel interference information in the neighbor station is taken into consideration, an average interference level the neighbor station receives is obtained for each channel, and a channels with the lowest average interference level is determined as a transmission channel so that more in number of neighbor stations can hear the transmission signal.

C-1. Channel setting method 1

It is assumed herein that each communication station transmits a beacon periodically, and that an amount of the interference on a terminal thereof through each channel is described as a piece of information in the beacon (See the above description and FIG. 8). Each communication station receives data through each channel for a predetermined time period at a periodical interval to obtain an average value of reception electric power level at the time of no signal so as to utilize the value as channel interference information of each channel. Each communication station receives a beacon of a neighbor terminal at a regular interval to grasp interference information of the neighbor stations.

It is necessary for the communication station to be the transmission side to decide the transmission channel on the basis of the channel interference information of the neighbor stations obtained from the beacons. Here, a weight based on the number of packets which the transmission station has transmitted during a certain fixed period is added to calculated a weighted average of the interference level.

For example, a case where only four communication stations A-D are present in a communication range and a communication station A selects a transmission channel is considered (See FIG. 14). It is assumed that the communication station A transmits data to each neighbor station as shown in Table 1 below during a previous certain fixed period. In addition, it is assumed that the interference level regarding a channel CH1 and a channel CH2 of each communication station is as shown in Table 2 below.

TABLE 1

| | COMMUNI- | COMMUNI- | COMMUNI- |
|---|---|---|---|
| TRANSMISSION | CATION | CATION | CATION |
| DESTINATION | STATION B | STATION C | STATION D |
| NUMBER OF | 100 PACKETS | 1000 PACKETS | 200 PACKETS |
| TRANSMITTED | | | |
| PACKETS | | | |

TABLE 2

| COMMUNI- | COMMUNI- | | COMMUNI- | | COMMUNI- | |
|---|---|---|---|---|---|---|
| CATION | CATION | | CATION | | CATION | |
| STATION | STATION B | | STATION C | | STATION D | |
| CHANNEL | CH1 | CH2 | CH1 | CH2 | CH1 | CH2 |
| INTERFERENCE | 1 | 10 | 10 | 1 | 2 | 5 |
| LEVEL | | | | | | |

In this case, the weighted average of the interference level of each channel of CH1 and CH2 for the communication station A is calculated to be equations (1) and (2), respectively.

$$\begin{matrix}[ Equation 1 ] \\ InterferenceLevelCH1 = \frac{1 * 100 + 10 * 1000 + 2 * 200}{100 + 1000 + 200} = 8.08 & ( 1 ) \\ InterferenceLevelCH2 = \frac{10 * 100 + 1 * 1000 + 5 * 200}{100 + 1000 + 200} = 2.31 & ( 2 )\end{matrix}$$

On the basis of the calculation results of the above equations, it is judged that CH2 is most suitable because it has a lower interference level so that the communication station A selects the channel CH2 as the transmission channel.

In this way, if the communication station carries out weighting the interference of a neighbor station with a high priority for the local station to obtain a weighted average for each channel, a channel with less interference for the prioritized neighbor station for the local station can be selected as the transmission channel. As a result, throughput of the entire system is improved.

In a case where a transmission destination receiving more transmission data is assigned with a channel with less interference, the less error and retransmission occur at where more data is transmitted. Accordingly, the data communication can be performed using a faster modulation speed and the throughput of the entire system is improved.

Such a channel selection is carried out at a regular interval, and the transmission channel is optimized in accordance with a change in neighbor environment and a change in a prioritized terminal.

C-2. Channel setting method 2

In a similar wireless communication environment to the above C-1, in this case, a case where the communication station B receives extremely large interference through the channel CH2 so that demodulation of the reception signal is almost impossible is considered.

A weight larger than a usual weight is added to the interference level of such a channel on which demodulation is not possible. For example, it is determined that the weight is 10 times as large as a measured value. In this case, the interference level per channel of each neighbor station is as shown in Table 3 below.

TABLE 3

| TERMINAL | TERMINAL B | | TERMINAL C | | TERMINAL D | |
|---|---|---|---|---|---|---|
| CHANNEL | CH1 | CH2 | CH1 | CH2 | CH1 | CH2 |
| INTERFERENCE | 1 | 100 | 10 | 1 | 2 | 5 |
| LEVEL | | | | | | |

In a case where the number of the transmitted packets during a certain period from the communication station A to the neighbor stations are as shown in the Table 1 above, the weighted average interference level of each channel of CH1 and CH2 for the communication station A is as shown in the following equations.

$$\begin{matrix}[ Equation 2 ] \\ InterferenceLevelCH1 = \frac{1 * 100 + 10 * 1000 + 2 * 200}{100 + 1000 + 200} = 8.08 & ( 3 ) \\ InterferenceLevelCH2 = \frac{100 * 100 + 1 * 1000 + 5 * 200}{100 + 1000 + 200} = 9.23 & ( 4 )\end{matrix}$$

Therefore, from a result of the above calculation, it is determined that the channel CH1 has a smaller interference level and the communication station A selects the channel CH1 as the transmission channel. As in the way described above, it is possible to prevent the channel CH2 being a channel having too large interference for the communication station B to demodulate a signal from being selected as the transmission channel. In other words, it is possible to prevent the communication station B from being disconnected from the network.

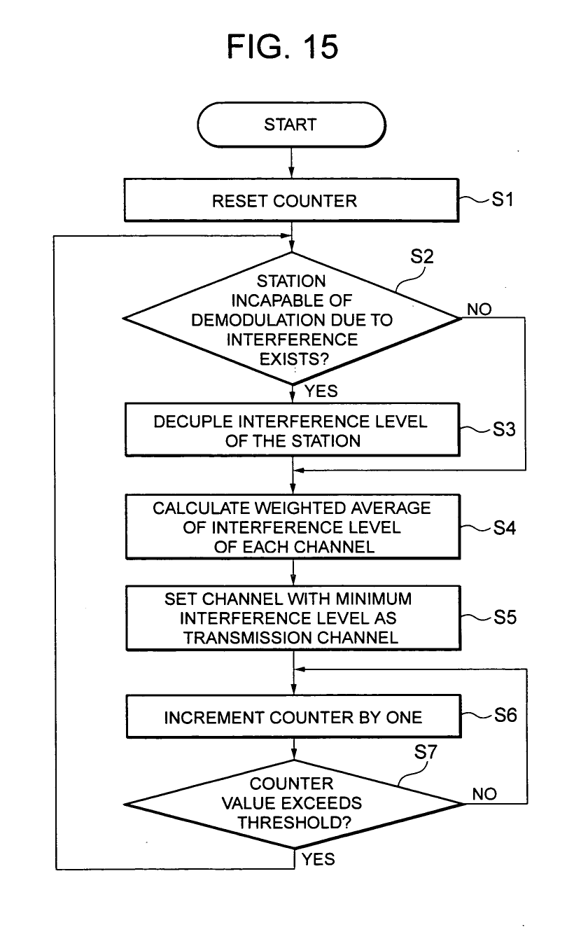

FIG. 15 shows processing steps, in a case where a channel receiving too heavy interference for a certain neighbor station to restore a signal exists, in a communication station for adding a larger weight to the channel to obtain a weighted average, in a form of flowchart. The processing steps shown in FIG. 15 is actually implemented in the form in which the central control unit 103 in the wireless communication apparatus executes an execution command program stored in the information storage unit 113 within the wireless communication apparatus 100 operating as the communication station.

First, a counter is reset (step S1).

Then, beacon information received from a neighbor station is analyzed to judge whether any neighbor station not capable of demodulation due to the interference exists or not.

In a case where such a neighbor station incapable of demodulation due to interference exists, a weight ten time as large as the interference level is added to each channel in the neighbor station (Step S3).

Subsequently, a weighted average of the interference level that each neighbor station receives in each channel is calculated (Step S4).

Then, a channel with a minimum weighted average of the interference level is set as the transmission channel (Step S5).

Subsequently, the counter is incremented by one (Step S6).

If the counter value exceeds a predetermined threshold, the process returns to Step S1 (Step S7), and calculation of the weighted average value of the interference level in each channel and selection of the transmission channel are repeatedly performed.

D. Neighbor Apparatus Information in a Multi-Channel Communication Environment

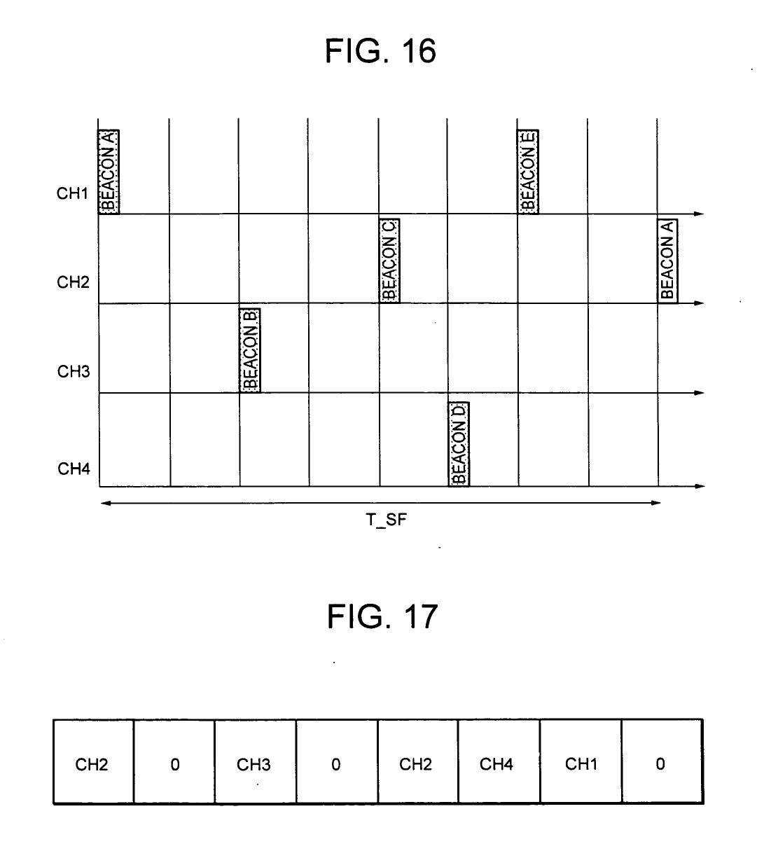

FIG. 16 shows a state where the communication stations A-D arrange the beacon transmission timing on each channel in a multi-channel communication system composed of four channels of CH1 to CH4. As shown in FIG. 16, each of the communication stations A-D arranges their beacon transmission timing in a mutually shifted manner so as not to collide with a beacon from the other stations. In addition, the channel through which a beacon is transmitted and received is set for each communication station on the basis of the channel quality information in the neighbor station, respectively.

If a smallest step of a beacon interval of each terminal is T_SF/8, in a case of the beacon transmission time and relative channel arrangement as shown in FIG. 16, it can be grasped as beacon position information described as shown in FIG. 17.

In an example shown in FIG. 17, the beacon position information has columns in the number of beacons which can be arranged within a transmission frame period T_SF. The head column is assigned to a beacon transmission position of the local station, and a beacon transmission channel is written therein. Each column subsequent thereto is assigned at the transmission time of every T_SF/8 using the beacon transmission position of the local station as a criterion, and the channel information of a beacon received at a relative position (offset) corresponding to the beacon transmission position of the local station is written therein.

The beacon position information as shown in FIG. 17 has information regarding whether or not a beacon of the transmission time corresponding to each column and, if there exists the beacon, information regarding the channel written therein, and the beacon position information corresponds to neighbor communication apparatus information NBOI in the multiple-channel communication environment. Each communication station creates beacon location information on the basis of the beacon which the local station could receive on each channel and write the information in the beacon to mutually notify to the neighbor stations so as to grasp the neighbor communication environment. In addition, each communication station fetches the beacon position information from the received beacon to update the content of the beacon position information in the local station.

The communication station obtains the beacon transmission channel in each transmission frame period on the basis of the description content of such beacon position information and switches to the obtained channel at the beacon transmission/reception time so as to try transmission/reception.

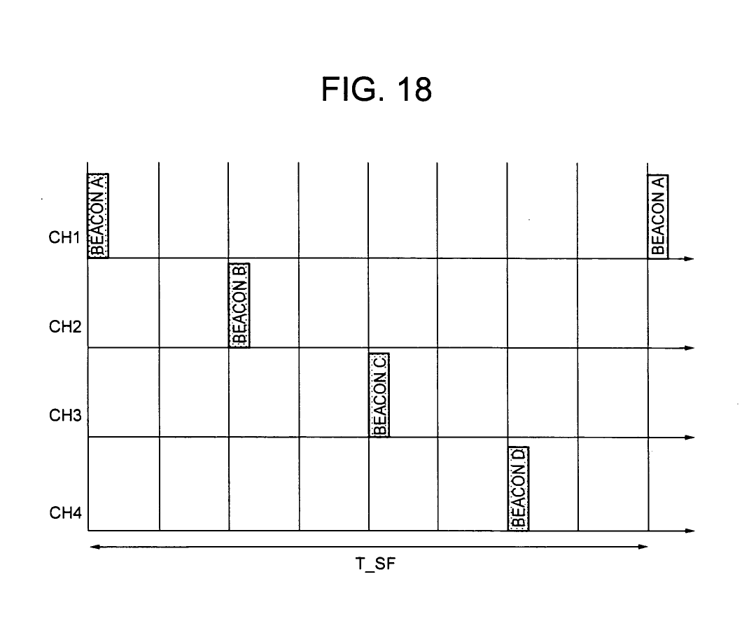

It is preferable that relative channel arrangement of the beacon is made so that the transmission time of each beacon is positioned as far as possible with each other. This is because, since data transmission in the transmission guaranteed period (TGP) acquired after the beacon transmission/reception is carried out on the channel of the beacon, communicable time can be longer if the beacons are separated as far as possible. FIG. 18 shows an example of beacon arrangement of each communication channel on the multiple channels.

The present invention has been described in detail with reference to particular embodiments. However, it is obvious that the person skilled in the art can make modifications and alternatives of the embodiments without departing from the gist of the present invention. Namely, the present invention has been disclosed illustratively, and the contents described in the specification should not be construed limitedly. In order to judge the gist of the present invention, Claims described below should be considered.

1. A wireless communication system for forming a network among a plurality of wireless communication apparatuses in a self-organized manner without having relationship of a controlling station and a controlled station, in a communication environment provided with a plurality of channels, wherein each communication station selects a channel from the plurality of channels on the basis of channel interference information in a neighbor station to perform communication.

2. The wireless communication system according to claim 1, wherein each communication station acquires communication quality regarding each of the plurality of channels and notify channel quality information describing the communication quality of each channel in a beacon transmitted at a predetermined time interval or in other form in order to consider the channel quality information with each other.

3. The wireless communication system according to claim 1, wherein each communication station obtains an average interference level that the neighbor station receives for each channel, and determines a channel with a lowest average interference level as a transmission channel.

4. The wireless communication system according to claim 3, wherein each communication station obtains a weighted average for every channel by adding a weight in accordance with a priority for the local station given to the neighbor station.

5. The wireless communication system according to claim 4, wherein each communication station adds a weight in accordance with an amount of transmission data transmitted during a predetermined period to each neighbor station to perform the weighted average calculation.

6. The wireless communication system according to claim 3, wherein, in a case where a channel receiving too large interference to restore a signal exists in a certain neighbor station, each communication station adds a weight larger than the interference level of the channel receiving the large interference in the neighbor station to obtain the weighted average.

7. A wireless communication apparatus operating in a self-organized distributed manner in a communication environment provided with a plurality of channels, comprising:
communication means for transmitting/receiving wireless data through each channel;
communication channel setting means for setting a transmission channel for a transmission signal of a local station in said communication means; and
control means for controlling a communication operation by said communication means on the channel set by said communication channel setting means, wherein:
said communication channel setting means selects a channel from the plurality of channels on the basis of channel interference information in a neighbor station.

8. The wireless communication apparatus according to claim 7, further comprising channel quality acquisition means for acquiring channel quality for the local station with regard to each of said plurality of channels.

9. The wireless communication apparatus according to claim 8, further comprising:
beacon signal generation means for generating a beacon signal describing information regarding the local station; and
beacon signal analysis means for analyzing a beacon signal received by said communication means from the neighbor station, wherein:
said beacon signal generation means generates the beacon including channel quality information describing the communication quality of each channel.

10. The wireless communication apparatus according to claim 8, wherein said channel quality acquisition means acquires the communication quality of each channel on the basis of a measurement result of a reception signal level in a case of no signal by said communications means.

11. The wireless communication apparatus according to claim 8 wherein said channel quality acquisition means measures an error rate of each channel in said communication means and acquires the communication quality of each channel on the basis of a measurement result thereof.

12. The wireless communication system according to claim 7, wherein said communication channel setting means obtains an average level of interference that the neighbor station receives for each channel, and determines a channel with a lowest average interference level as a transmission channel.

13. The wireless communication system according to claim 12, wherein said communication channel setting means obtains a weighted average for every channel by adding a weight in accordance with a priority for the local station given to the neighbor station.

14. The wireless communication system according to claim 13, wherein said communication channel setting means adds a weight in accordance with an amount of transmission data transmitted during a predetermined period to each neighbor station to perform the weighted average calculation.

15. The wireless communication system according to claim 12, wherein, in a case where a channel receiving too large interference to restore a signal exists in a certain neighbor station, said communication channel setting means adds a weight larger than the interference level of the channel receiving the large interference in the neighbor station to obtain the weighted average.

16. A wireless communication method for operating in a self-organized distributed manner in a communication environment provided with a plurality of channels, comprising:
a communication channel setting step for setting a transmission channel for a transmission signal of a local station; and
a control step for controlling a communication operation on the channel set in the communication channel setting step, wherein:
in the communication channel setting step, the channel is selected from the plurality of channels on the basis of channel interference information in a neighbor station.

17. The wireless communication method according to claim 7, further comprising a channel quality acquisition step for acquiring channel quality for the local station with regard to each of said plurality of channels.

18. The wireless communication method according to claim 17, further comprising:
a beacon signal generation step for generating a beacon signal describing information regarding the local station; and
a beacon signal analysis step for analyzing the beacon signal received by said communication means from the neighbor station, wherein:
in said beacon signal generation step, a beacon including channel quality information describing the communication quality of each channel is generated.

19. The wireless communication method according to claim 18, wherein, in said channel quality acquisition step, the communication quality of each channel is acquired on the basis of a measurement result of a reception signal level in a case of no signal by said communications means.

20. A computer program written in a computer readable format so as to execute a processing for performing wireless communication on a computer system in a self-organized distributed manner in a wireless communication environment provided with a plurality of channels, comprising:
a communication channel setting step for setting a transmission channel for a transmission signal of a local station; and
a control step for controlling a communication operation on the channel set in said communication channel setting step, wherein:
in said communication channel setting step, the channel is selected from said plurality of channels on the basis of channel interference information in a neighbor station.
